(19) United States
(12) Patent Application Publication
(10) Pub. No.: US 2026/0034802 A1
(43) Pub. Date: Feb. 5, 2026

(54) PRINTING DEVICE AND CONTROL METHOD FOR PRINTING DEVICE

(71) Applicant: SEIKO EPSON CORPORATION, Tokyo (JP)

(72) Inventors: Hiroyoshi OKADA, MATSUMOTO-SHI (JP); Hironori MAEKAWA, SUWA-SHI (JP); Toshiyuki SASAKI, YAMAGATA-MURA (JP)

(21) Appl. No.: 19/284,893

(22) Filed: Jul. 30, 2025

(30) Foreign Application Priority Data
Aug. 2, 2024 (JP) 2024-127779

(51) Int. Cl. B41J 2/35; B41J 3/407; B41J 13/00

(52) U.S. Cl. CPC B41J 2/35; B41J 3/407; B41J 13/0027

(57) ABSTRACT

A printing device 1 includes a transport section 60 configured to transport a print medium in a transport direction, a transport driver circuit 50 configured to drive the transport section 60, a print head 70 configured to print an image based on print data on the print medium, and a control section 100 configured to control the transport driver circuit 50 and the print head 70 to execute a first print mode and a second print mode different from the first print mode, wherein the control section 100 is configured to change a transport amount by which the print medium is transported in the transport direction while the image based on the print data is printed on the print medium between a case where the first print mode is executed and a case where the second print mode is executed.

The present application is based on, and claims priority from JP Application Serial Number 2024-127779, filed Aug. 2, 2024, the disclosure of which is hereby incorporated by reference herein in its entirety.

### BACKGROUND

### 1. Technical Field

The present disclosure relates to a printing device and a control method for a printing device.

### 2. Related Art

In the related art, a technique for reducing the amount of a print medium used for printing an image is known.

For example, a printing device disclosed in JP-A-2017-124572 executes a process of determining, based on the developed data obtained by developing, in units of rows, font data corresponding to each character of character information included in the print data, whether or not a predetermined margin is present in the developed data at least on one of the upper and lower sides in the row direction reducing, in units of rows, the predetermined margin of the developed data in units of rows, and causing a printing section to perform printing.

However, since the printing device of JP-A-2017-124572 reduces the margin included in the developed data, the intervals of characters and pictures are narrowed, and the printed content of the printed matter may become difficult to see.

### SUMMARY

A printing device according to the present disclosure includes a transport section configured to transport a print medium in a transport direction; a drive section configured to drive the transport section; a printing section configured to print an image based on print data on the print medium; and a control section configured to control the drive section and the printing section to execute a first print mode and a second print mode different from the first print mode, wherein the control section is configured to change, between when the first print mode is executed and when the second print mode is executed, transport amount by which the print medium is transported in the transport direction while the image based on the print data is printed on the print medium.

A control method for a printing device, the printing device including a transport section configured to transport a print medium in a transport direction, a drive section configured to drive the transport section, and a printing section configured to print an image based on print data on the print medium, the control method includes a processor included in the printing device executing a step of controlling the drive section and the printing section to cause the printing device to execute a first print mode and a step of controlling the drive section and the printing section to cause the printing device to execute a second print mode different from the first print mode and a transport amount by which the print medium is transported in the transport direction while the image based on the print data is printed on the print medium in the step of executing the second print mode is different from a transport amount by which the print medium is transported in the transport direction while the image based on the print data is printed on the print medium in the step of executing the first print mode.

### BRIEF DESCRIPTION OF THE DRAWINGS

FIG. 1 is a diagram showing a configuration of a printing device.

FIG. 2 is a diagram showing an image printed in a first print mode and an image printed in a second print mode.

FIG. 3 is a diagram showing signal waveforms of an encoder signal and a strobe signal.

FIG. 4 is a flowchart showing an operation of the printing device.

### DESCRIPTION OF EMBODIMENTS

### 1. Configuration of Printing Device

Hereinafter, a configuration of a printing device 1 of the present embodiment will be described with reference to the accompanying drawings.

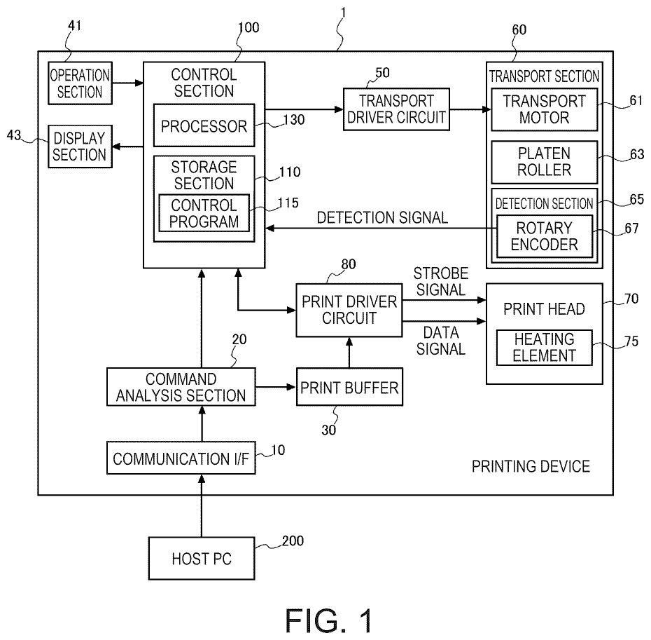

FIG. 1 is a diagram showing a configuration of the printing device 1.

The printing device 1 includes a communication interface 10, a command analysis section 20, a print buffer 30, an operation section 41, a display section 43, a transport driver circuit 50, a transport section 60, a print head 70, a print driver circuit 80, and a control section 100. Hereinafter, the interface is also referred to as an I/F.

The communication I/F 10 includes a connection port and an interface circuit, and communicates with a host computer 200 in accordance with a predetermined communication standard. Hereinafter, the computer is abbreviated as PC. The host PC 200 is an external device that transmits print data to the printing device 1 and causes the printing device 1 to print an image based on the print data, or transmits a control command to the printing device 1 and causes the printing device 1 to execute a process corresponding to the control command.

The command analysis section 20 analyzes the data received by the communication I/F 10. When the received data is a control command, the command analysis section 20 outputs the control command to the control section 100, and when the received data is print data, generates, for example, binary image data based on the print data and develops the generated image data into the print buffer 30.

The operation section 41 is a reception section that receives an operation for changing the operation mode of the printing device 1. The operation section 41 may be, for example, a hardware switch such as a dip switch provided in the printing device 1, or may be a touch panel provided in the printing device 1.

The display section 43 includes a display panel such as a liquid crystal panel, and displays information on the display panel under the control of the control section 100.

The transport driver circuit 50 supplies a drive current to a transport motor 61 and rotationally drives the transport motor 61 under the control of the control section 100. The transport driver circuit 50 corresponds to a drive section. The transport motor 61 is a drive source that transports the print medium, and can be configured by, for example, a DC motor.

The transport section 60 includes the transport motor 61, a platen roller 63, and a detection section 65. The detection section 65 includes a rotary encoder 67.

The transport motor 61 is driven by the transport driver circuit 50 and rotates the platen roller 63.

The platen roller 63 holds the print medium between itself and the print head 70, and transports the print medium in a transport direction by being rotated by the transport motor 61. The platen roller 63 contacts the print medium from the opposite side of the print head 70, thereby causing the print head 70 to contact roll paper and causing the print head 70 to print characters and graphics on the print medium.

The rotary encoder 67 detects the rotation of the platen roller 63 and outputs an encoder pulse. The rotary encoder 67 includes, for example, a disk fixed to an end section of the platen roller 63 and a photosensor. The disk is provided with a large number of slits in the peripheral edge section, for example. A central axis of the disk coincides with a rotation axis of the platen roller 63, and the disk also rotates with the rotation of the platen roller 63. Each time each slit provided in the peripheral edge section of the disk passes the position of the photosensor, the amount of light received by the photosensor changes in a binary manner. Therefore, when the platen roller 63 rotates, the photosensor generates a detection signal including a large number of pulses. The rotary encoder 67 outputs the generated detection signal to the control section 100.

In the present embodiment, a case where the rotary encoder 67 detects the rotation of the platen roller 63 will be described as an example, but the rotary encoder 67 may be configured to detect the rotation of a rotation shaft of the DC motor constituting the transport motor.

The print head 70 corresponds to a printing section and includes a plurality of heating elements 75. The print head 70 is a line thermal head in which the heating elements 75 are disposed in a one dot line in a width direction of the print medium, which intersects the transport direction of the print medium. The resolution in the width direction in which the heating elements 75 of the print head 70 are arranged is referred to as a head resolution.

The print driver circuit 80 drives the print head 70 under the control of the control section 100. The print head 70 is a line thermal head that prints the image by forming dots on the print medium by the plurality of heating elements 75 arranged in the width direction of the print medium.

The print driver circuit 80 transmits a control signal to the print head 70 to control driving of the print head 70. The control signal output from the print driver circuit 80 to the print head 70 includes a strobe signal STB and a data signal.

The strobe signal STB is a signal that defines an energization time of the heating elements 75. When the signal level of the data signal becomes active while the signal level of the strobe signal STB is active, the corresponding heating element 75 is energized and generates heat.

The data signal is bit data for one dot line. The print driver circuit 80 acquires bit data for one dot line from the bit data developed in the print buffer 30, and outputs the acquired bit data for one dot line to the print head 70.

The control section 100 is a computer device including a storage section 110 and a processor 130.

The storage section 110 includes a memory such as a random access memory (RAM) or a read only memory (ROM). The RAM is used to temporarily store various data and the like, and the ROM stores a control program 115 for controlling the operation of the printing device 1, various setting information, and the like.

The processor 130 is a calculation processing device including a central processing unit (CPU) or a micro processing unit (MPU). The processor 130 executes the control program 115 to control each section of the printing device 1. The processor 130 may be configured by a single processor or a plurality of processors. The processor 130 may be configured by a part or all of the storage section 110 or an SoC integrated with other circuits. The processor 130 may be configured by a combination of a CPU that executes a program and a DSP that executes predetermined arithmetic processing. Further, all of the functions of the processor 130 may be implemented in hardware or may be configured using a programmable device.

The printing device 1 has a first print mode and a second print mode as print modes.

The first print mode is a mode in which the length of the print medium in the transport direction is not reduced when the image based on the print data is printed on the print medium.

The second print mode is a mode in which the length of the print medium in the transport direction is reduced to be smaller than that in the first print mode when the image based on the print data is printed on the print medium.

The first print mode and the second print mode are different from each other in the transport amount of the print medium in the transport direction while the image based on the print data is being printed on the print medium.

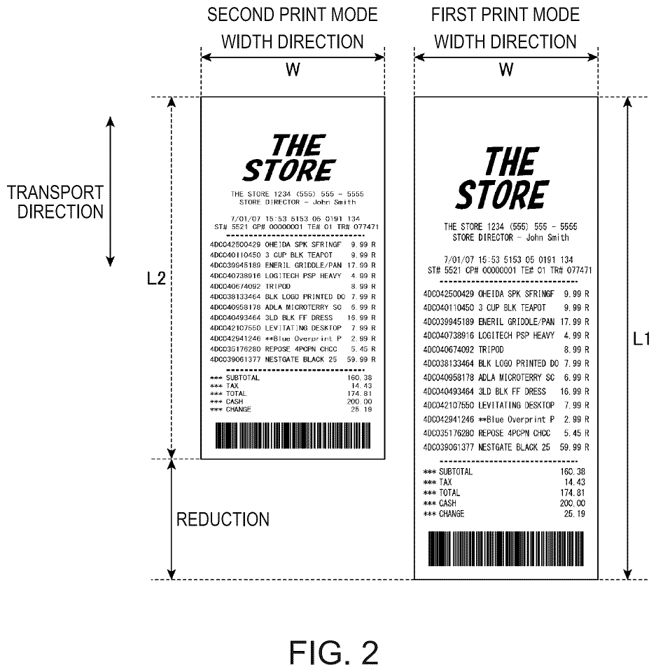

FIG. 2 is a diagram showing a receipt image printed in the first print mode and a receipt image printed in the second print mode.

In the drawing, the receipt image printed in the first print mode is shown on the right side, and the receipt image printed in the second print mode is shown on the left side.

As shown in FIG. 2, the length W in the width direction of the receipt image printed in the first print mode and the receipt image printed in the second print mode is the same.

The length of the receipt image printed in the first print mode in the transport direction is L1, and the length of the receipt image printed in the second print mode in the transport direction is L2. The L2 is shorter in length than the L1. That is, the size of the receipt image printed in the second print mode in the transport direction is reduced compared to the receipt image printed in the first print mode.

Since the image printed in the second print mode is reduced in the transport direction, it is possible to suppress the interval between the characters or pictures included in the image from being extremely reduced and to reduce the appearance of the printed image from being greatly changed, compared to a case where the margin is deleted.

Since the change in appearance between the print data and the image printed on the print medium can be reduced as compared with the case where the margin is deleted, it is easy to create the print data for printing the image that is easily viewed by the user.

In the present embodiment, a case where the printing device 1 includes two modes of the first print mode and the second print mode as the print mode will be described, but the number of print modes included in the printing device 1 is not limited to two. For example, the printing device 1 may be configured to have three print modes, that is, the first print mode, the second print mode, and a third print mode. The third print mode is a mode in which the length of the print medium in the transport direction is reduced to be smaller than that in the second print mode.

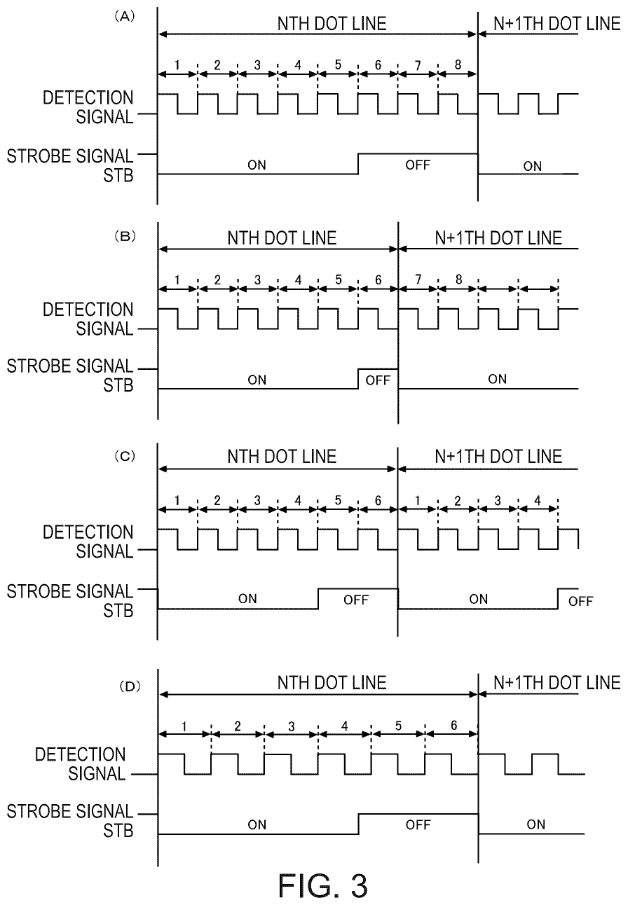

FIG. 3 is a diagram showing signal waveforms of the detection signal and the strobe signal STB in the Nth dot line and the N+1th dot line. N is an arbitrary natural number.

(A) of FIG. 3 is a diagram showing signal waveforms of the detection signal and the strobe signal STB in a case where the first print mode is executed. FIG. 3 shows the signal that becomes active when the signal level is low and energizes the corresponding heating element 75 as the strobe signal STB.

In the first print mode, one cycle of the strobe signal STB corresponds to eight cycles of the detection signal. That is, while the print driver circuit 80 outputs the strobe signal STB for one cycle to the print head 70, the rotary encoder 67 outputs the detection signal for eight cycles to the control section 100. The ON period of the strobe signal STB shown in (A) of FIG. 3 corresponds to five cycles of the detection signal, and the OFF period of the strobe signal STB corresponds to three cycles of the detection signal.

For example, when the head resolving power is assumed to be 203 dpi, in the first print mode, the transport amount of the transport motor 61 of the transport section 60 is defined so that the print resolution is 203 dpi, which is the same as the print resolution.

(B) of FIG. 3 shows a case where one cycle of the strobe signal STB is reduced to six cycles of the detection signal, and the ON period of the strobe signal STB is set to five cycles of the detection signal which is the same as that in the first print mode. The OFF period of the strobe signal STB corresponds to one cycle of the detection signal.

In the first print mode, the print head 70 is often used at the rated power of the print head 70. In the case of the usage example shown in (B) of FIG. 3, one cycle of the strobe signal STB is shortened to six cycles of the detection signal without changing the length of the ON period of the strobe signal STB from that in the first print mode. Therefore, the ratio of the OFF period to one cycle of the strobe signal STB decreases, and the ratio of the ON period to one cycle of the strobe signal STB increases. Therefore, the energy become excessive, and becomes a source of failure of the print head 70. In order to suppress failure of the print head 70, it is necessary to set the duty ratio of the strobe signal STB to be equal to or less than the duty ratio of the strobe signal STB in the first print mode shown in (A) of FIG. 3.

(C) of FIG. 3 shows a case where one cycle of the strobe signal STB is shortened to six cycles of the detection signal, and the duty ratio of the strobe signal STB is set to be the same as that in the first print mode.

In order to suppress the failure of the print head 70, it is necessary to set the ratio of the ON period to one cycle of the strobe signal STB to be equal to or less than that in the first print mode. However, when the ON period of the strobe signal STB is shortened compared to the first print mode as shown in (C) of FIG. 3, the print density may be lower than that in the first print mode.

(D) of FIG. 3 is a diagram showing signal waveforms of the detection signal and the strobe signal STB in a case where the printing device 1 performs printing in the second print mode.

One cycle of the strobe signal STB in the second print mode is the same as one cycle of the strobe signal STB in the first print mode shown in (A) of FIG. 3. The duty ratio of the strobe signal STB in the second print mode is also the same as the duty ratio of the strobe signal STB in the first print mode. That is, the cycle and the duty ratio of the strobe signal STB are not changed between the case of executing the first print mode and the case of executing the second print mode.

In the second print mode, the strobe signal STB is not changed, and the transport amount by which the print medium is transported in the transport direction is made different from that in the first print mode.

As shown in (D) of FIG. 3, in the second print mode, while the print driver circuit 80 outputs the strobe signal STB for one cycle to the print head 70, the rotary encoder 67 outputs the detection signal for six cycles to the control section 100. That is, the timing at which the rotary encoder 67 outputs the detection signal during one cycle of the strobe signal STB is delayed compared to the case of the first print mode. Therefore, a second transport amount of the print medium transported by the transport section 60 while the print head 70 performs printing of a preset number of lines in the transport direction in the second print mode is smaller than a first transport amount of the print medium transported by the transport section 60 while the print head 70 performs printing of the preset number of lines in the transport direction in the first print mode. That is, the transport amount by which the transport section 60 transports the print medium is smaller than that in the first print mode. By this, the size of the image printed on the print medium in the transport direction is reduced.

The setting information stored in the storage section 110 includes a reduction ratio in the transport direction in the second print mode. When the printing device 1 is set to the second print mode by the operation of the operation section 41 or the like, the control section 100 controls the transport driver circuit 50 so that the second transport amount of the print medium becomes a transport amount corresponding to the reduction ratio of the second print mode.

In a case where the printing device 1 includes the third print mode in addition to the first print mode and the second print mode, the setting information stored in the storage section 110 includes the reduction ratio in the transport direction in the third print mode in addition to the reduction ratio in the transport direction in the second print mode. When the printing device 1 is set to the third print mode by the operation of the operation section 41 or the like, the control section 100 controls the transport driver circuit 50 so that the transport amount of the print medium becomes a transport amount corresponding to the reduction ratio of the third print mode.

The print mode of the printing device 1 may be changed by a hardware switch such as a dip switch provided in the printing device 1.

The setting may be received by a touch panel provided in the printing device 1, and the setting of the print mode stored as the setting information by the storage section 110 may be rewritten.

For example, in the first print mode, it is assumed that the print resolution in a case of a configuration in which the encoder outputs the detection signal for eight cycles while printing the image for one dot line is 203 dpi. It is assumed that the printing speed in the first print mode is 300 mm/s.

In the case of the second print mode in which the encoder outputs the detection signal for six cycles while the print head 70 prints the image for one dot line, the print resolution is 271 dpi, the printing speed is 226 mm/s, and the printing speed is slower than that in the first print mode.

It is assumed that as the third print mode, the mode is set in which the encoder outputs the detection signal for seven cycles while the print head 70 prints the image for one dot line. In this case, the print resolution is 232 dpi and the printing speed is 264 mm/s.

Even if the printing speed is reduced by the reduction ratio, the same information can be printed with a paper feed amount shorter by the reduction ratio, and therefore, the issue time does not change.

When the disk in which the number of slits provided in the peripheral edge section of the disk of the rotary encoder 67 is increased is prepared, the number of cycles of the detection signal output by the encoder can be increased while the image corresponding to one dot line is printed in the first print mode, and thus it is easy to set the reduction ratio of the second print mode or the third print mode more finely.

In order to reduce a change in the density of the image printed on the print medium between the case of executing the first print mode and the second print mode, the control section 100 may increase or decrease the ON time of the strobe signal within the rated power of the print head 70.

The storage section 110 may store a preset energization time, and the control section 100 may control the energization time, that is, the duty ratio, of the plurality of heating elements based on the preset energization time when the second print mode is executed.

This energization time is an energization time adjusted before product shipment of the printing device 1 so as to reduce a difference between the print density of the image printed on the print medium in a case of executing the first print mode and the print density of the image printed on the print medium in a case of executing the second print mode.

Therefore, when the second print mode is executed, by causing the print head 70 to execute printing based on the preset energization time, it is possible to suppress the occurrence of a change in the print density between the case of executing the first print mode and the case of executing the second print mode.

### 2. Operation of Printing Device

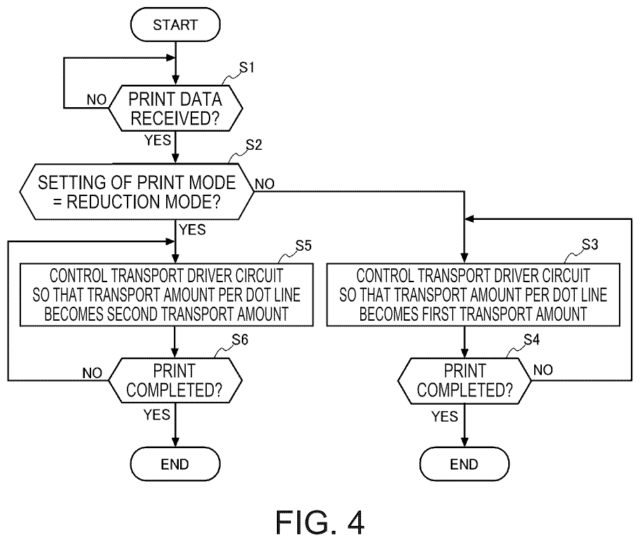

FIG. 4 is a flowchart showing an operation of the printing device 1.

The operation of the printing device 1 will be described with reference to the flowchart shown in FIG. 4.

First, the control section 100 determines whether or not print data has been received from the host PC 200 (step S1). When the control section 100 has not received print data from the host PC 200 (step S1: NO), the control section 100 waits until print data is received.

When the control section 100 receives the print data (step S1: YES), the control section 100 determines whether or not the print mode set in the printing device 1 is the second print mode (step S2). When the print mode is not the second print mode (step S2: NO) but rather is the first print mode, the control section 100 controls the transport driver circuit 50 according to the determined print mode (step S3). In detail, the control section 100 controls the transport driver circuit 50 so that the transport amount of the print medium transported in the transport direction while printing the image of one dot line becomes the first transport amount (step S3).

Thereafter, the control section 100 determines whether or not the printing of the image based on the print data received in step S1 is completed (step S4). When the printing of the image based on the print data is not completed (step S4: NO), the control section 100 returns to the process of step S3. When the printing of the image based on the print data is completed (step S4: YES), the control section 100 ends the process flow.

When the print mode is the second print mode (step S2: YES), the control section 100 controls the transport driver circuit 50 according to the determined print mode (step S5). In detail, the control section 100 controls the transport driver circuit 50 so that the transport amount of the print medium transported in the transport direction while printing an image for one dot line becomes the second transport amount (step S5). The second transport amount is smaller than the first transport amount.

Thereafter, the control section 100 determines whether or not printing of the image based on the print data received in step S1 is completed (step S6). When the printing of the image based on the print data is not completed (step S6: NO), the control section 100 returns to the process of step S5. When the printing of the image based on the print data is completed (step S6: YES), the control section 100 ends the process flow.

### 3. Modifications

In this modification, the print data to be printed by the printing device 1 includes data in a predetermined format. The data in the predetermined format includes, for example, image data such as a logo or a picture of a product, a one dimensional code such as a barcode, and a two dimensional code such as a QR code. QR code is a registered trademark.

When the second print mode is to be executed and the control section 100 receives an operation from the operation section 41 to print the print data of the predetermined format in the second print mode, the control section 100 causes the print head 70 to print the print data including the data of the predetermined format in the second print mode.

When the second print mode is to be executed and the control section 100 receives an operation from the operation section 41 to print data of the predetermined format in the first print mode, the control section 100 causes the transport driver circuit 50 to transport the print medium by the first transport amount when the data of the predetermined format is printed. When print data other than in the predetermined format is to be printed, the transport driver circuit 50 causes transport of the print medium by the second transport amount.

The data in the predetermined format may not be included in the print data received from the host PC 200. For example, the data in the predetermined format may be stored in the storage section 110 in advance. When printing of data in the predetermined format is instructed by a command included in print data, the control section 100 reads the data in the predetermined format from the storage section 110 and outputs the read data in the predetermined format to the print driver circuit 80. The print driver circuit 80 superimposes the data in the predetermined format input from the control section 100 on the image data developed in the print buffer 30.

The embodiment and the modifications described above are desired embodiments of the present disclosure. However, the present disclosure is not limited to this, and various modifications can be made without departing from the gist of the present disclosure.

For example, the process units of the flowchart shown in FIG. 4 are divided according to the main process contents in order to facilitate understanding of the process of the printing device 1. The present disclosure is not limited by the way of division of the process units and the names of the process units shown in the flowchart of FIG. 4. The processes of the printing device 1 may be divided into more process units according to the process contents, or may be divided so that one process unit includes more processes. The process order of the flowchart is not limited to the shown example.

Each functional unit of the printing device 1 shown in FIG. 1 indicates a functional configuration realized by cooperation of hardware and software, and a specific implementation form is not particularly limited. Therefore, the hardware individually corresponding to each functional unit does not necessarily need to be mounted, and it is of course possible to adopt a configuration in which the functions of a plurality of functional units are realized by one processor executing a program. In the above embodiment, a part of the functions realized by software may be realized by hardware, or a part of the functions realized by hardware may be realized by software.

### 4. Summary of Present Disclosure

Hereinafter, a summary of the present disclosure is appended.

### Appendix 1

A printing device includes a transport section configured to transport a print medium in a transport direction; a drive section configured to drive the transport section; a printing section configured to print an image based on print data on the print medium; a control section configured to control the drive section and the printing section to execute a first print mode and a second print mode different from the first print mode, wherein the control section is configured to change, between when the first print mode is executed and when the second print mode is executed, transport amount by which the print medium is transported in the transport direction while the image based on the print data is printed on the print medium.

According to this configuration, the transport amount by which the print medium is transported in the transport direction is changed while the image based on the print data is printed on the print medium in the case of executing the first print mode and in the case of executing the second print mode. Therefore, the size of the image printed on the print medium in the transport direction can be changed, and the amount of the print medium used can be reduced.

### Appendix 2

The printing device according to Appendix 1, wherein the control section is configured to control the drive section such that a second transport amount of the print medium transported by the transport section while the printing section performs printing of a preset number of lines in the transport direction in the second print mode is smaller than a first transport amount of the print medium transported by the transport section while the printing section performs printing of the preset number of lines in the transport direction in the first print mode.

According to this configuration, the second transport amount, which is the transport amount of the print medium while printing is performed for the preset number of lines in the transport direction in the second print mode, is smaller than the first transport amount, which is the transport amount of the print medium while printing is performed for the preset number of lines in the transport direction in the first print mode. Therefore, the size in the transport direction of the image printed on the print medium in the second print mode can be reduced to be smaller than the size in the transport direction of the image printed on the print medium in the first print mode.

### Appendix 3

The printing device according to Appendix 2, wherein in the second print mode, a reduction ratio in the transport direction is set and the control section is configured to control the drive section so that the second transport amount becomes a transport amount corresponding to the reduction ratio.

According to this configuration, the control section is configured to control the drive section so that the second transport amount becomes the transport amount corresponding to the reduction ratio. Therefore, it is possible to print the image in which the size of the image in the transport direction is reduced to a size corresponding to the reduction ratio.

### Appendix 4

The printing device according to Appendix 1, further includes an operation section configured to receive an operation, wherein the printing section includes a thermal head and the control section is configured to, when the second print mode is executed, change an energization time of the thermal head according to a setting of a print density received by the operation section.

According to this configuration, the energization time for energizing the thermal head is changed according to the setting of the print density received by the operation section. Therefore, the density of the image printed on the print medium can be changed by operating the operation section.

### Appendix 5

The printing device according to Appendix 1, wherein the printing section includes a thermal head, the thermal head includes a plurality of heating elements, and the control section is configured to control the energization time of the plurality of heating elements by outputting a strobe signal to the thermal head and not change a cycle and a duty ratio of the strobe signal between when the first print mode is executed and when the second print mode is executed.

According to this configuration, the cycle and the duty ratio of the strobe signal are not changed between when the first print mode is executed and when the second print mode is executed. Therefore, it is possible to suppress an increase in the ratio of the ON period to one cycle of the strobe signal, and to suppress a failure of the printing section due to excessive energy.

### Appendix 6

The printing device according to Appendix 1, wherein the printing section includes a thermal head, the thermal head includes a plurality of heating elements, the control section includes a storage section configured to store a preset energization time of the plurality of heating elements, the control section is configured to control the energization time of the plurality of heating elements by outputting a strobe signal to the thermal head and cause the printing section to execute printing based on the preset energization time when the second print mode is executed, based on the preset energization time, and the preset energization time is an energization time set so as to reduce a difference between a print density of an image printed on the print medium when the first print mode is executed and a print density of an image printed on the print medium when the second print mode is executed.

According to this configuration, when the second print mode is executed, the energization time of the plurality of heating elements included in the thermal head is controlled based on the preset energization time stored in the storage section. Since the preset energization time stored in the storage section is an energization time set so that the density difference between the print density of the image printed on the print medium when the first print mode is executed and the print density of the image printed on the print medium when the second print mode is executed is reduced, it is possible to suppress the occurrence of a change in the print density of the image printed on the print medium between the first print mode and the second print mode.

### Appendix 7

The printing device according to Appendix 4, further includes a detection section configured to detect rotation of the transport section or rotation of the drive section, wherein the drive section is a DC motor and the detection section includes a rotary encoder configured to detect rotation of a rotation shaft of the DC motor.

According to this configuration, the rotation of the rotation shaft of the DC motor that is the drive section can be detected by the rotary encoder. For example, by increasing the number of slits of the disk of the rotary encoder, it is possible to finely change the size in the transport direction of the image printed on the print medium.

### Appendix 8

The printing device according to Appendix 1, further includes an operation section configured to receive an operation, wherein the control section is configured to change print mode executed by the printing device to the first print mode or to the second print mode in response to the operation received by the operation section.

According to this configuration, the print mode to be executed by the printing device can be changed to the first print mode or the second print mode by operating the operation section.

### Appendix 9

The printing device according to Appendix 2, further includes an operation section configured to receive an operation, wherein the control section is configured to, when the second print mode is to be executed and also data in a predetermined format is included in the print data to be printed by the printing section, determine whether to print the data in a predetermined format in the first print mode or in the second print mode according to a setting received by the operation section and cause the printing section to print the data in the predetermined format in accordance with the determined print mode.

According to this configuration, it is determined whether the data of the predetermined format is printed in the first print mode or the second print mode according to the setting received by the operation section when the second print mode is executed and the data of the predetermined format is included in the print data to be printed by the printing section. Therefore, when the data of the predetermined format is printed, the data of the predetermined format can be printed in the first print mode or the second print mode according to the setting received by the operation section.

### Appendix 10

The printing device according to Appendix 9, wherein the data in the predetermined format includes at least one of image data, a one dimensional code, and a two dimensional code.

According to this configuration, when the print data includes at least one of the image data, the one dimensional code, and the two dimensional code, it is possible to select whether to print the data in the predetermined format in the first print mode or in the second print mode. Therefore, it is possible to prevent the data of the predetermined format from being reduced without the user's intention.

### Appendix 11

A control method for a printing device, the printing device including a transport section configured to transport a print medium in a transport direction, a drive section configured to drive the transport section, and a printing section configured to print an image based on print data on the print medium, the control method includes a processor included in the printing device executing a step of controlling the drive section and the printing section to cause the printing device to execute a first print mode and a step of controlling the drive section and the printing section to cause the printing device to execute a second print mode different from the first print mode and a transport amount by which the print medium is transported in the transport direction while the image based on the print data is printed on the print medium in the step of executing the second print mode is different from a transport amount by which the print medium is transported in the transport direction while the image based on the print data is printed on the print medium in the step of executing the first print mode.

According to this configuration, the transport amount by which the print medium is transported in the transport direction is changed while the image based on the print data is printed on the print medium in the case of executing the first print mode and in the case of executing the second print mode. Therefore, the size of the image printed on the print medium in the transport direction can be changed, and the amount of the print medium used can be reduced.

What is claimed is:

1. A printing device comprising:
a transport section configured to transport a print medium in a transport direction;
a drive section configured to drive the transport section;
a printing section configured to print an image based on print data on the print medium; and
a control section configured to control the drive section and the printing section to execute a first print mode and a second print mode different from the first print mode, wherein
the control section is configured to change, between when the first print mode is executed and when the second print mode is executed, transport amount by which the print medium is transported in the transport direction while the image based on the print data is printed on the print medium.

2. The printing device according to claim 1, wherein
the control section is configured to control the drive section such that a second transport amount of the print medium transported by the transport section while the printing section performs printing of a preset number of lines in the transport direction in the second print mode is smaller than a first transport amount of the print medium transported by the transport section while the printing section performs printing of the preset number of lines in the transport direction in the first print mode.

3. The printing device according to claim 2, wherein
in the second print mode, a reduction ratio in the transport direction is set and
the control section is configured to control the drive section so that the second transport amount becomes a transport amount corresponding to the reduction ratio.

4. The printing device according to claim 1, further comprising:
an operation section configured to receive an operation, wherein
the printing section includes a thermal head and
the control section is configured to, when the second print mode is executed, change an energization time of the thermal head according to a setting of a print density received by the operation section.

5. The printing device according to claim 1, wherein
the printing section includes a thermal head,
the thermal head includes a plurality of heating elements, and
the control section is configured to
control the energization time of the plurality of heating elements by outputting a strobe signal to the thermal head and
not change a cycle and a duty ratio of the strobe signal between when the first print mode is executed and when the second print mode is executed.

6. The printing device according to claim 1, wherein
the printing section includes a thermal head,
the thermal head includes a plurality of heating elements,
the control section includes a storage section configured to store a preset energization time of the plurality of heating elements,
the control section is configured to
control the energization time of the plurality of heating elements by outputting a strobe signal to the thermal head and
cause the printing section to execute printing based on the preset energization time when the second print mode is executed, based on the preset energization time, and
the preset energization time is an energization time set so as to reduce a difference between a print density of an image printed on the print medium when the first print mode is executed and a print density of an image printed on the print medium when the second print mode is executed.

7. The printing device according to claim 4, further comprising:
a detection section configured to detect rotation of the transport section or rotation of the drive section, wherein
the drive section is a DC motor and
the detection section includes a rotary encoder configured to detect rotation of a rotation shaft of the DC motor.

8. The printing device according to claim 1, further comprising:
an operation section configured to receive an operation, wherein
the control section is configured to change print mode executed by the printing device to the first print mode or to the second print mode in response to the operation received by the operation section.

9. The printing device according to claim 2, further comprising:
an operation section configured to receive an operation, wherein
the control section is configured to
when the second print mode is to be executed and also data in a predetermined format is included in the print data to be printed by the printing section, determine whether to print the data in a predetermined format in the first print mode or in the second print mode according to a setting received by the operation section and
cause the printing section to print the data in the predetermined format in accordance with the determined print mode.

10. A printing device according to claim 9, wherein
the data in the predetermined format includes at least one of image data, a one dimensional code, and a two dimensional code.

11. A control method for a printing device, the printing device including
a transport section configured to transport a print medium in a transport direction, a drive section configured to drive the transport section, and a printing section configured to print an image based on print data on the print medium,
the control method comprising:
a processor included in the printing device executing
a step of controlling the drive section and the printing section to cause the printing device to execute a first print mode and
a step of controlling the drive section and the printing section to cause the printing device to execute a second print mode different from the first print mode and
a transport amount by which the print medium is transported in the transport direction while the image based on the print data is printed on the print medium in the step of executing the second print mode is different from a transport amount by which the print medium is transported in the transport direction while the image based on the print data is printed on the print medium in the step of executing the first print mode.
